(19) United States
(12) Patent Application Publication
(10) Pub. No.: US 2013/0097011 A1
(43) Pub. Date: Apr. 18, 2013

(54) Online Advertisement Perception Prediction

(71) Applicants: Taifeng Wang, Beijing (CN); Tie-Yan Liu, Beijing (CN); Bin Gao, Beijing (CN); Tao Qin, Beijing (CN)

(72) Inventors: Taifeng Wang, Beijing (CN); Tie-Yan Liu, Beijing (CN); Bin Gao, Beijing (CN); Tao Qin, Beijing (CN)

(73) Assignee: MICROSOFT CORPORATION, Redmond, WA (US)

(21) Appl. No.: 13/273,924

(22) Filed: Oct. 14, 2011

(51) Int. Cl. G06Q 30/02

(52) U.S. Cl. 705/14.45; 705/14.41

(57) ABSTRACT

An advertisement perception predictor may forecast the effectiveness of an online advertisement in a web page by predicting whether the online advertisement may be perceived by a consumer. The advertisement perception predictor may use a perception model that is trained for determining perception probability values of online advertisements. The perception model may be applied to an online advertisement to determine a perception probability value for the online advertisement. The perception probability value may indicate the likelihood that a consumer is likely to view the online advertisement.

### BACKGROUND

Online advertising is an advertisement delivery technique that delivers advertising content via web pages to attract consumers. In some instances, an advertiser may spend up to thirty percent of its entire advertising budget for the placement of online advertisements on designated websites. In turn, website owners that host online advertisements may charge advertisers based on the number of impressions per advertisement that are displayed to consumers. However, such online advertisement pricing plans may not account for the actual effectiveness of the online advertisements in reaching consumers. For example, such pricing plans may be based on the assumption that the higher the number of advertisement impressions that are displayed, the higher the return on investment (ROI) to an advertiser for those displayed advertisement impressions. However, in real world scenarios, the effectiveness of an online advertisement and the associate ROI may at best partially correlate with the number of impressions of the advertisement that are shown.

### SUMMARY

Described herein are techniques for implementing an advertisement perception predictor that predicts whether an online advertisement may be perceived by a consumer. In other words, the advertisement perception predictor may forecast the effectiveness of an online advertisement by predicting whether the online advertisement is likely to be viewed by consumers. In this way, the value of an online advertisement may be gauged by the ability of the online advertisement to affect consumer behavior rather than in terms of the number of times that the online advertisement is delivered to consumers for viewing. Thus, the ability to predict whether an online advertisement is likely to be viewed by consumers may enable the adoption of an online advertising pricing model that more closely parallels the expectations of the online advertisers in the amount of returns for their online advertising investments.

In at least one embodiment, the advertisement perception predictor may use a perception model that is trained for determining perception probability values of online advertisements. The perception model may be applied to an online advertisement to determine a perception probability value for the online advertisement. The perception probability value may indicate the likelihood that a consumer is likely to view the online advertisement.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram that illustrates an example scheme that implements an advertisement perception predictor.

FIG. 2 is a block diagram that shows selected illustrative components of an electronic device that implements the advertisement perception predictor.

FIG. 3 is a flow diagram that illustrates an example process for implementing a perception model for predicting an online advertisement perception probability for an online advertisement and valuating online advertisement impressions of the online advertisement.

FIG. 4 is a flow diagram that illustrates an example process for training a perception model for predicting online advertisement perception probabilities.

FIG. 5 is a flow diagram that illustrates an example process for obtaining a perception probability value for an online advertisement using the perception model.

### DETAILED DESCRIPTION

The embodiments described herein pertain to techniques for implementing an advertisement perception predictor that predicts whether an online advertisement may be viewed by a user. The advertisement perception predictor may use a perception model to predict the effectiveness of an online advertisement in causing a viewing of the online advertisement by a user. The perception model may predict whether the online advertisement may be perceived by the user based on features associated with the online advertisement. In at least one embodiment, the perception model may be a supervised learning model, such as a support vector machine (SVM) classifier model, that is trained based on correlations between features in multiple online advertisements and labeled data regarding whether users perceived the multiple online advertisements. The features associated with each online advertisement may include the position of an online advertisement in a displayed web page, the proximity of the online advertisement to a hyperlink embedded in the displayed web page, the visual attractiveness of the online advertisement relative to the content of the displayed web page, and/or other features that may influence consumer interaction with the online advertisement.

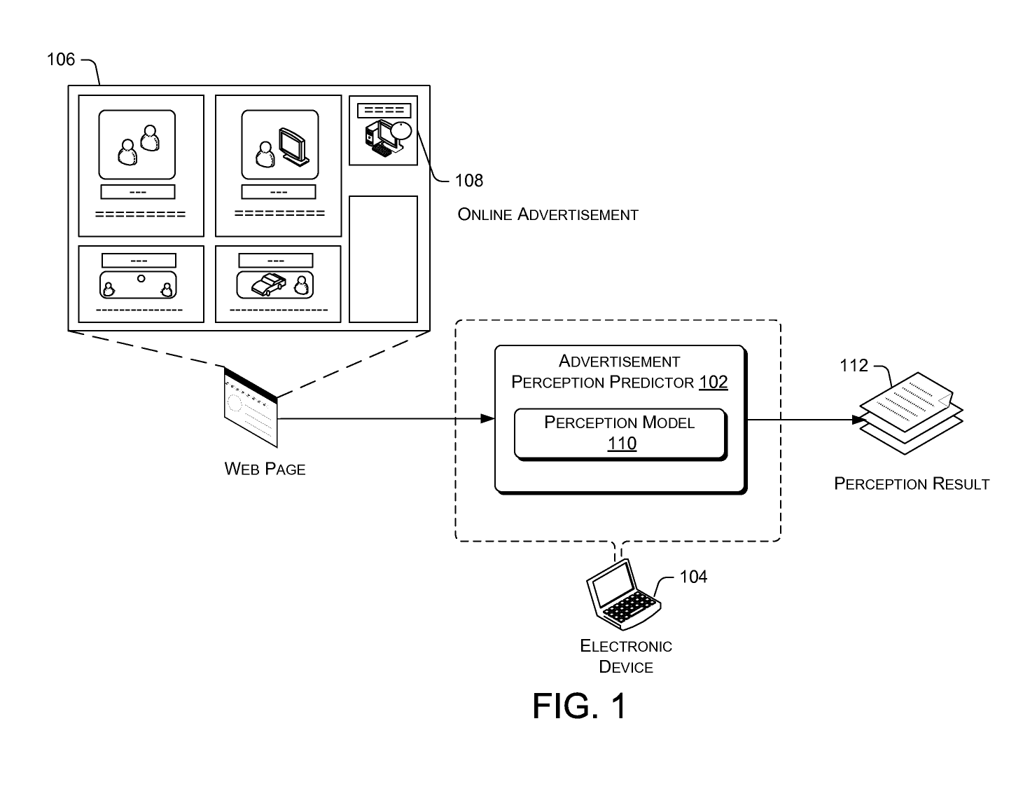

Thus, the advertisement perception predictor may enable online advertisers to estimate the value of an online advertisement based on the predicted ability of the online advertisement to attract consumer attention. Accordingly, the predicted values of online advertisements may enable online advertisers and websites hosts to adopt a new online advertising pricing model. The new online advertising pricing model may more closely parallel the expectations of the online advertisers in receiving returns on their online advertising investments. Various examples of techniques for implementing the advertisement perception predictor in accordance with the embodiments are described below with reference to FIGS. 1-5.

### Example Scheme

FIG. 1 is a block diagram that illustrates an example scheme 100 that implements an advertisement perception predictor 102. The advertisement perception predictor 102 may be implemented by an electronic device 104. The advertisement perception predictor 102 may receive one or more web pages that include online advertisements, such as a web page 106 that includes an online advertisement 108. In turn, the web page 106 may be analyzed by the advertisement perception predictor 102 so that features associated the online advertisement 108 may be quantified. The features of the online advertisement 108 may include the position of the online advertisement 108 in the web page 106, the proximity of the online advertisement 108 to a hyperlink embedded in the web page 106, the visual attractiveness of the online advertisement 108 relative to the content of the web page 106, and/or other features that may influence consumer interaction with the online advertisement 108.

Once the features of the online advertisement 108 are quantified, the advertisement perception predictor 102 may then process the quantified features based on a perception model 110 to determine a perception result 112. In at least one embodiment, the perception model 110 may be a supervised learning model, such as a support vector machine (SVM) classifier model, that is trained based on correlations between features in multiple online advertisements and labeled data regarding whether users viewed the multiple online advertisements. The perception result 112 may be a perception probability value that indicates the probability that a consumer is likely to view the online advertisement 108 as presented in the web page 106.

Accordingly, in the same manner, the advertisement perception predictor 102 may use the features of each online advertisement in conjunction with the perception model 110 to predict a perception probability value for each online advertisement in the one or more web pages. In some embodiments, the advertisement perception predictor 102 may also calculate a cost of displaying impressions of each online advertisement to consumers based on a corresponding perception probability value of each online advertisement.

### Electronic Device Components

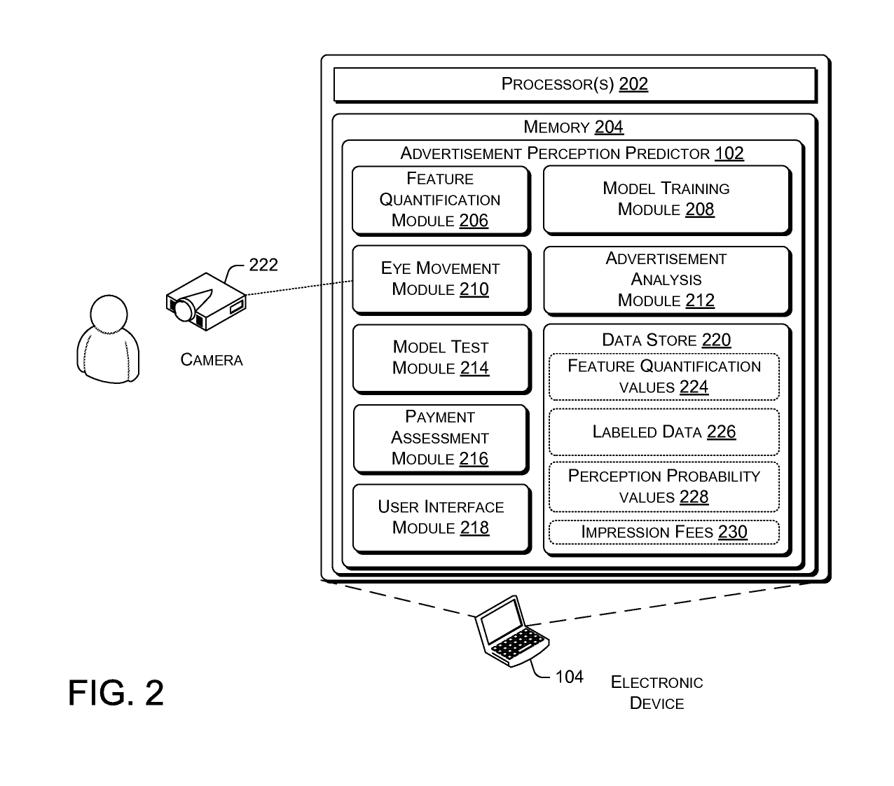

FIG. 2 is a block diagram that shows selected illustrative components of an electronic device 104 that implements the advertisement perception predictor 102. In various embodiments, the electronic device 104 may be a general purpose computer, such as a desktop computer, a tablet computer, a laptop computer, a server, and so forth. However, in other embodiments, the electronic device 104 may be one of a camera, a smart phone, a game console, a personal digital assistant (PDA), and so forth.

The electronic device 104 may include one or more processors 202, memory 204, and/or user controls that enable a user to interact with the electronic device. The memory 204 may be implemented using computer readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

The electronic device 104 may have network capabilities. For example, the electronic device 104 may exchange data with other electronic devices (e.g., laptops computers, servers, etc.) via one or more networks, such as the Internet. In some embodiments, the electronic device 104 may be substituted with a plurality of networked servers, such as servers in a cloud computing network.

The one or more processors 202 and the memory 204 of the electronic device 104 may implement components that include a feature quantification module 206, a model training module 208, an eye movement tracking module 210, an advertisement analysis module 212, a payment assessment module 216, a user interface module 218, and a data store 220.

The feature quantification module 206 may quantify the features associated with each of a plurality of online advertisements, such as the online advertisement 108. In various embodiments, the feature quantification module 206 may use a machine classification algorithm to detect features in a web page (e.g., web page 106) that are associated with an online advertisement, as well as assign a quantification value to each feature. The machine classification algorithm may use image recognition and classification techniques to detect features and assign quantification value based on each feature observed. Each quantification value may indicate whether a corresponding feature is present or not present, or alternatively, a magnitude of the feature that is present. In various embodiments, each of the features associated with an online advertisement may be a factor that impacts the way a consumer perceives the online advertisement. For example, at least some of the features that impact the way a consumer view a particular online advertisement are described below in Table I.

TABLE 1
Features for Modeling Perception Probability Analysis

| Feature Category | Description | Feature |
|---|---|---|
| Display screen- | Given a displayed web | Probability distribution of |
| based | page on a screen, a user | attention based on position |
| feature | tends to place more | of advertisement within a |
| | attention on some key | web page that is displayed |
| | region. | on a screen (float) |
| Browsing | When a user selects | 1. The distance between an |
| behavior | hyperlinks on a web | advertisement and a |
| features | page, the user may be | selectable hyperlink on the |
| | more likely to view | web page (float) |
| | advertisements that are | 2. Stay time on the web page |
| | closest to each hyperlink. | (float) |
| | Further, when a user's | 3. Stay time on a displayed |
| | stay time with a web | portion of the web page that |
| | page increases, the | shows the advertisement |
| | chance that the user | (float) |
| | perceives an | |
| | advertisement on the web | |
| | page also increases. | |
| Web page | User viewing of content | 1. Advertisement close to |
| functionality | may vary according to | title (Boolean) |
| features | regions of a web page | 2. Advertisement in main |
| | with different | content region (Boolean) |
| | functionalities. | 3. Advertisement in a right |
| | | navigation bar (Boolean) |
| | | 4. Advertisement in a right |
| | | navigation bar (Boolean) |
| Advertisement | Visual appeal of an | 1. Advertisement contrast |
| visual | image in the | (float) |
| features | advertisement displayed | 2. Advertisement brightness |
| | on a web page. | (float) |
| | | 3. Advertisement |
| | | colorfulness (float) |
| | | 4. Advertisement motion |
| | | (Boolean) |
| Proximate | An advertisement is more | 1. Image around the |
| web page | likely to catch the | advertisement (Boolean) |
| visual features | attention of a user when | 2. Color contrast between |
| | the background area of | the web page and |
| | the proximate to the web | advertisement (float) |
| | page is comparatively | 3. Flashing content around |
| | plain. | the advertisement (float) |
| Brand | An advertisement is more | Recognition of brand in |
| recognition | likely to catch the | advertisement (float) |
| feature | attention of a user when | |
| | the advertisement is | |
| | related to a brand | |
| | recognized by the user | |

As shown in Table I, there are several categories of features that may impact the way that a consumer views the online advertisement. These categories may include a display screen-based feature category, a web page functionality feature category, an advertisement visual feature category, a proximate web page visual feature category, and a brand recognition feature category. In turn, the display screen-based feature category may include a feature that quantifies a probability distribution of a user's attention based on the position of an advertisement in a display screen. The browsing behavior feature category may include features that quantify a user's behavior with respect to one or more hyperlinks and viewing of the web page that include the online advertisement.

The advertisement visual feature category may include features that quantify the visual appeal of each image in the online advertisement. For example, these features may include contrast, brightness, colorfulness, and motion. The surrounding web page visual feature category may include features that quantify the visual appeal of web page content that are proximate to the online advertisement. For example, these features may include whether an image is present near the online advertisement shown in the web page, whether there is color contrast between the web page and the online advertisement, and whether there is flashing content around the online advertisement as shown on the web page.

The “brand recognition” feature may be a feature that quantifies whether users recognizes a brand that is shown in each online advertisement. For example, an advertisement is more likely to catch the attention of a user when the advertisement is related to a brand recognized by the user.

The feature quantification module 206 may assign a quantification value to each detected feature associated with an online advertisement. In various embodiments, the quantification value assigned to each of the features may be a Boolean value or a float value. For a feature that is quantified with a Boolean value, the Boolean value may indicate whether the feature is present or not present. For example, with respect to the “close to title” feature that is included in the web page functionality features category, the feature quantification module 206 may assign a Boolean value of “1” if the closest distance between an online advertisement and a title in the web page is equal to or less than a predetermined threshold. Conversely, the feature quantification module 206 may assign a Boolean value of “0” to the “close to title” feature when the closest distance between the online advertisement and the title in the web page is less than a predetermined threshold.

On the other hand, for a feature that is quantified with a float value, the float value may provide a magnitude of the feature. For example, for the “probability distribution of attention” feature that is in the display screen-based feature category, the feature quantification module 206 may assign a float value that represents the probability that a consumer is likely to pay attention to the online advertisement. For example, the feature quantification module 206 may assign a float value 9.0 out of 10 to the feature when the online advertisement is within a first predetermined area of a web page. Alternatively, the feature quantification module 206 may assign a float value of 8.0 out of 10 to the feature when the online advertisement is within a second predetermined area of the web page that is less likely to receive attention from the user. In some embodiments, the numerical scale for the float values of the different features may be standardized. However, in other embodiments, at least one of the features that are quantified with a float value may use a different numerical scale.

With respect to the “brand recognition” feature, the feature quantification module 206 may assign a float quantification value based on user input data regarding the popularity of different brands. For example, the user input data may be gathered by performing a user survey of a predetermined sample of people (e.g., 100 survey participants). Each person in the survey may be provided with a list of brands, and asked to rate the popularity of each brand on a numerical scale. The numerical scale may range from “0” to “10” based on increments of one, in which a rating of “10” correlates with a rating of most popular, and a rating of “0” indicates a rating of least popular or unknown. The survey results from the participants may then be processed (e.g., averaged) to obtain a float value for each brand on the list of brands. Accordingly, when an online advertisement mentions a particular brand from the list of rated brands, the feature quantification module 206 may assign the corresponding float value to the “brand recognition” feature associated with the online advertisement. However, in some embodiments, if an online advertisement does not mention a particular brand from the list of rated brands, the feature quantification module 206 may assign a float value of “0” to the “brand recognition” feature associated with the online advertisement to indicate the complete lack of brand recognition.

The model training module 208 may develop a perception model 110 that is eventually used to assign a perception value to each new online advertisement that is displayed on a web page. As described above, the perception value may indicate the probability that a consumer is likely to view the corresponding online advertisement. Thus, the goal of the model training module 208 is to obtain a function GO that takes the features associated with a new online advertisement and generate the perception value as the output. Accordingly, output of the function GO may be expressed as:

p=G(f₁, f₂, . . . fₙ; ω₁, ω₂, . . . , ωₙ) (1)

in which fᵢ represents a feature, ωᵢ is a parameter of the perception model 110, which indicates the importance of a corresponding feature.

In at least one embodiment, the perception model 110 may be a SVM classifier model. Generally speaking, a SVM classifier model may be trained with the use of a set of training samples in which each sample is marked as belonging to one of two classes. Once trained, the SVM classifier model may be further used to classify a new input into one of the two classes. In the context of the perception model 110, the training sample may come from manually supplied results or automated eye movement tracking results.

In the case of manually supplied results, one or more users may be asked to rate a group of samples, in which each sample is a web page-advertisement pair that was previously shown to each user. The web page part of a web page-advertisement pair is a web page that is configured to display an online advertisement, and the advertisement part of the web page is an online advertisement that is shown in the web page. In rating each sample, each user may study a description of an online advertisement. The user may then indicate whether the user previously viewed the online advertisement in the corresponding web page, or failed to view the online advertisement. In instances in which a single web page displays multiple online advertisements, multiple webpage-advertisement pairs may be present for the single web page. The description of each online advertisement may include an explanation of the online advertisement, an image of the web page that included the online advertisement, a brand name mentioned in the online advertisement, and/or other details.

In the case of eye movement tracking results, the model training module 208 may implement the eye movement tracking module 210 to directly ascertain whether each of the one or more users viewed an online advertisement in the web page of a sample. In various embodiments, the eye movement tracking module 210 may track the pupil movement of each user via a camera 222 as the each user looks at the samples. From the detected pupil movement of a user, the eye movement tracking module 210 may develop a heat map that shows locations in the web pages of the samples that the user viewed. Accordingly, when at least one location that the user viewed for a predetermined amount of time corresponds to a portion of the web page that shows an online advertisement of a sample, the eye movement tracking module 210 may determine that the user viewed the online advertisement of the sample. Conversely, when none of the locations that the users viewed for the predetermined amount of time corresponds to a portion of the web page that shows an online advertisement of a sample, the eye movement tracking module 210 may determine that the user failed to view the online advertisement of the sample.

The model training module 208 may then apply a SVM classifier to the group of samples to train the model parameters ω₁, ω₂, . . . , ωₙ and generate the perception model 110. Accordingly, a piece of training data from the group of samples may be represented as follows:

(fᵢ₁, fᵢ₂, . . . fᵢₙ; yᵢ)

in which i is the index of a sample that is a web page-advertisement pair, fᵢₙ is the nth feature of an i web page-advertisement pair, and yᵢ is a view status label (1, −1) of the sample with the index i. The value of yᵢ may be “1” when the corresponding online advertisement of the sample with the index i is viewed, as indicated by manually supplied or eye movement tracking results. Conversely, the value of yᵢ may be “−1” when the corresponding online advertisement of the sample with the index i is unviewed. In this way, the model training module 208 may train the perception model 110 using multiple pieces of training data.

In additional embodiments, the model training module 208 may also develop the perception model 110 using other classifiers and/or machine learning techniques. For example, the techniques may make use of supervised learning, unsupervised learning, semi-supervised learning, and such. For example, various classification schemes (explicitly and/or implicitly trained) and/or systems (e.g., support vector machines, neural networks, expert systems, Bayesian belief networks, fuzzy logic, data fusion engine, and/or so forth) may be employed. Other directed and undirected model classification approaches include, e.g., ad boost, naïve Bayes, Bayesian networks, gradient decision trees, neural networks, fuzzy logic models, and probabilistic classifier models may also be employed. Such techniques may be used to develop the perception model 110 based on the quantification values assigned to features of online advertisements and labeled data regarding viewing or lack of viewing of the online advertisements.

The advertisement analysis module 212 may use the perception model 110 to determine a perception probability value for each new online advertisement that is displayed in a corresponding webpage. In various embodiments, the advertisement analysis module 212 may receive a new web page that includes one or more online advertisements. As an example, the advertisement analysis module 212 may capture an image of the web page 106 that includes the online advertisement 108. For each of the online advertisements in a web page, the advertisement analysis module 212 may use the feature quantification module 206 to assign a quantification value to each of the features associated with the online advertisement. The advertisement analysis module 212 may then provide the features quantification values as input data to the perception model 110 for processing.

In turn, the advertisement analysis module 212 may use the perception model 110 to predict whether an online advertisement is viewed or not viewed based on the corresponding input data. The use of the perception model 110 may also produce a classification confidence value in addition to the viewed or not viewed prediction for the online advertisement. The classification confidence value may function as a perception probability value that indicates the probability that a consumer is likely to view the online advertisement. For example, the perception probability value may be expressed as a percentage value, in which a higher percentage value indicates a higher likelihood of being viewed, while a lower percentage value indicates a lower likelihood of being viewed. However, in another example, the perception probability value may be expressed as a numerical value on a numerical scale, in which a higher numerical value indicates a higher likelihood of being viewed, while a lower numerical value indicates a lower likelihood of being viewed.

In some embodiments, the advertisement analysis module 212 may use a model test module 214 to test the perception model 110 prior to determine the perception probability values for new online advertisements. The testing of the perception model 110 verifies that the perception model 110 is able to produce acceptable perception probability values for the new online advertisements. The test may be performed using the samples of web page-advertisement pairs that are used by the model training module 208 to train the perception model 110. In various embodiments, the model test module 214 may process each sample web page-advertisement pair using the perception model 110 to generate a corresponding test perception probability value. The test perception probability value of a sample web page-advertisement pair is then compared to the labeled view status of the sample web page-advertisement pair.

Thus, the model test module 214 may determine that a perception model 110 is acceptable when a predetermined amount of the sample web page-advertisement pairs that are tested by the model test module 214 have test perception probability values that are within a predetermined threshold range of the corresponding labeled view statuses. For example, when the labeled view status of an online advertisement is “viewed”, a test perception probability value for the corresponding webpage-advertisement pair that is in the range of 51%-100% may be deemed to be within the predetermined threshold range of the labeled view status “viewed”. Likewise, when the labeled view status of an online advertisement is “unviewed”, a test perception probability value for the corresponding webpage-advertisement pair that is in the range of 0%-50% may be deemed to be within the predetermined threshold range of the labeled view status “unviewed”.

In another example, when the labeled view status of an online advertisement is “viewed”, a test perception probability value for the corresponding webpage-advertisement pair that is in the range of 5.1-10 points on a 10-point scale may be deemed to be within the predetermined threshold range of the labeled view status “viewed”. Likewise, when the labeled view status of an online advertisement is “unviewed”, a test perception probability value for the corresponding webpage-advertisement pair that is in the range of 0-5.0 points on a 10-point scale may be deemed to be within the predetermined threshold range of the labeled view status “unviewed”.

In various embodiments, the predetermined amount of the sample web page-advertisement pairs may be a percentage amount (e.g., 90%). Thus, when the amount of sample web page-advertisement pairs that have test perception probability values within respective predetermined threshold ranges is equal to or greater than the percentage amount, the model test module 214 may determine that the perception model 110 passed the test. Otherwise, the model test module 214 may determine that the perception model 110 failed the test. In such a failure scenario, the model test module 214 may report the failure to the advertisement analysis module 212. In turn, the advertisement analysis module 212 may command the model training module 208 to re-training a new perception model. The training of the new perception model may involve the use of new or modified training data.

The payment assessment module 216 may determine fees that are charged for the display of each online advertisement based on a corresponding perception probability value. The fees may be charged by a website host to an online advertiser. In some embodiments, the payment assessment module 216 may determine the fee for each impression of an online advertisement exposed to a consumer in proportion or in inverse proportion to the perception probability value of the online advertisement. For example, a higher perception probability value may result in a higher fee being assessed for each impression of a corresponding online advertisement. Conversely, a lower perception probability value may result in a lower fee being assessed for each impression of the corresponding online advertisement.

Alternatively, the payment assessment module 216 may determine a fee that is charged for each impression of an online advertisement by taking into account the perception probability value in conjunction with a click-through rate (visits per number of impressions) and/or sale conversion rate (i.e., sales per number of impressions) that resulted from the displays of the online advertisement in a predetermined period of time.

In some embodiments, the payment assessment module 216 may assign a valuation score to each online advertisement based on the magnitudes of a corresponding perception probability value, a corresponding click-through rate, and/or a corresponding sale conversion rate. Accordingly, a higher valuation score may result in the assessment of a higher fee for showing an impression of a corresponding online advertisement, while a lower valuation score may result in a lower fee for showing an impression of a corresponding online advertisement. However, in other instances, the payment assessment module 216 may be configured so that a higher valuation score may result in the assessment of a lower fee for showing an impression of a corresponding online advertisement, while a lower valuation score may result in a higher fee for showing an impression of a corresponding online advertisement.

In other embodiments, a tiered fee assessment structure may be used by the payment assessment module 216 in conjunction with the valuation scores obtained for the online advertisements. In such a structure, each score range in a group of different score ranges may be assigned a corresponding fee amount. Thus, depending on which range the valuation score of an online advertisement falls into, the payment assessment module 216 may assess the corresponding fee for showing an impression of the online advertisement. Alternatively, the payment assessment module 216 may calculate a fee that is charged for each impression of an online advertisement in proportion or in inverse proportion to the value of the corresponding valuation score. For example, a higher valuation score may result in a higher fee being assessed for each impression of a corresponding online advertisement. Conversely, a lower valuation score may result in a lower fee being assessed for each impression of the corresponding online advertisement.

In a few instances, the payment assessment module 216 may weigh the perception probability value, the click-through rate, and/or the sale conversion rate of each online advertisement during the calculation of corresponding valuation scores. The weight assigned to each factor (e.g., value or rate) may be dependent on the determined importance of the factor. For example, if the perception probability rate of an online advertisement is twice as important in the determination of an impression fee as the sale conversion rate, the payment assessment module 216 may assigned a corresponding weight to each factor to reflect their importance.

The user interface module 218 may enable a user to interact with the modules on the electronic device 104 using a user interface (not shown). The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods.

In various embodiments, the user interface module 218 may enable a user to adjust various threshold values and settings used by the modules of the advertisement perception predictor 102. For example, a user may use the user interface module 218 to adjust the assignment of the float and Boolean feature quantification values by the feature quantification module 206, input training data into the model training module 208, and/or adjust the computation technique used by the payment assessment module 216 to calculate the impression fees.

The data store 220 may store the feature quantification values 224 that are obtained for each online advertisement, the labeled data 226 for the model training module 208, as well as the perception model 110. The data store 220 may also store the perception probability values 228 obtained for the online advertisements, as well as any value, score, or rate used to compute the impression fees 230 for displaying the online advertisements. Additionally, the data store 220 may also store values or other intermediate products that are generated or used by various modules of the advertisement perception predictor 102.

### Example Processes

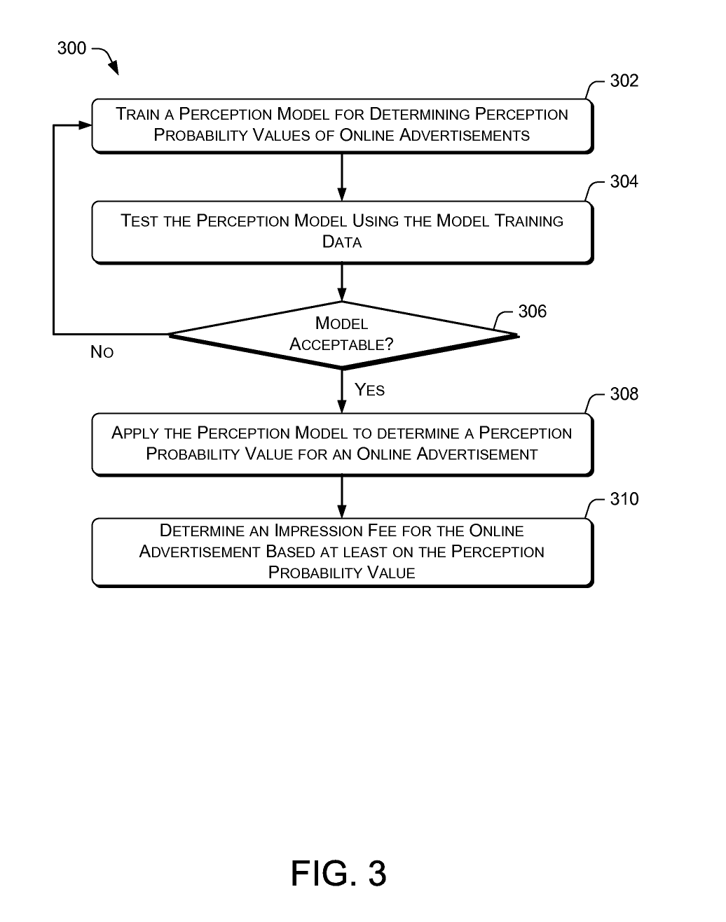

FIGS. 3-5 describe various example processes for implementing an advertisement perception predictor. The order in which the operations are described in each example process is not intended to be construed as a limitation, and any number of the described operations may be combined in any order and/or in parallel to implement each process. Moreover, the operations in each of the FIGS. 3-5 may be implemented in hardware, software, and a combination thereof. In the context of software, the operations represent computer-executable instructions that, when executed by one or more processors, cause one or more processors to perform the recited operations. Generally, computer-executable instructions include routines, programs, objects, components, data structures, and so forth that cause the particular functions to be performed or particular abstract data types to be implemented.

FIG. 3 is a flow diagram that illustrates an example process 300 for implementing a perception model for predicting an online advertisement perception probability for an online advertisement and valuating online advertisement impressions of the online advertisement. At block 302, the model training module 208 may train a perception model 110 for determining the perception probability values of online advertisements. The online advertisements may be presented in web pages. For example, the web page 106 may display an online advertisement 108. The perception probability value for each online advertisement is a value that indicates the probability that a consumer is likely to view the corresponding online advertisement.

In at least one embodiment, the perception model 110 may be a supervised learning model, such as a support vector machine (SVM) classifier model that is trained using model training data. The perception model 110 may be trained by applying a machine learning classifier (e.g., SVM classifier) to the feature quantification values of the samples of web page-advertisement pairs and labeled view status data.

At block 304, the model test module 214 may test the perception model 110 to determine whether the perception model 110 produces acceptable perception probability values 228 for online advertisements. In various embodiments, the test of the perception model 110 may be performed using the sample web page-advertisement pairs that are used by the model training module 208 to train the perception model 110.

At decision block 306, if the model test module 214 determines that the perception model 110 is not capable of producing acceptable perception probability values 228 (“no” at decision block 306), the process 300 may loop back to block 302 so that another perception model may be trained. In various embodiments, the training of the new perception model may involve the use of new or modified training data. However, if the model test module 214 determines that the perception model 110 is capable of producing acceptable perception probability values 228 (“yes” at decision block 306), the process 300 may continue to block 308.

At block 308, the advertisement analysis module 212 may apply the perception model 110 to determine a perception probability value for an online advertisement. In various embodiments, the advertisement analysis module 212 may input the feature quantification values associated with the online advertisement into the perception model 110 to compute the perception probability value for the online advertisement.

At block 310, the payment assessment module 216 may determine an impression fee for the online advertisement based at least on the perception portability value of the online advertisement. The impression fee may be a fee that a website host charges an online advertiser who owns the online advertisement for showing each impression of the online advertiser to consumers. In some embodiments, the payment assessment module 216 may determine the impression fee for an online advertisement based on a sale conversion rate and/or click-through, in addition to the perception probability value.

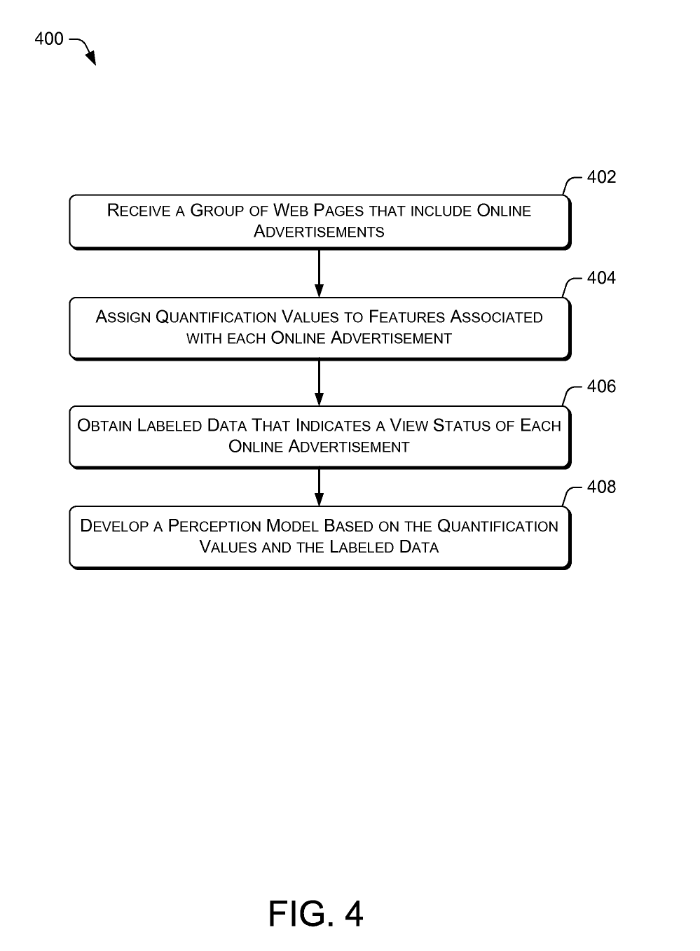

FIG. 4 is a flow diagram that illustrates an example process 400 for training a perception model for predicting online advertisement perception probabilities. The example process 400 further illustrates block 302 of the example process 300.

At block 402, the model training module 208 may receive a group of web pages that include online advertisements for training a perception model, such as the perception model 110. In some instances, each web page may include one or more online advertisements. In various embodiments, the online advertisements may include a hyperlink that enables a consumer to navigate to a different web page, as well as text or graphics.

At block 404, the model training module 208 may use the feature quantification module 206 to assign quantification values to the features associated with each of the online advertisements. In various embodiments, the feature quantification module 206 may use a machine classification algorithm to detect features in a corresponding web page that are associated with each online advertisement and assign quantification values to such features.

Each quantification value may indicate whether a corresponding feature is present or not present, or a magnitude of the feature that is present. In various embodiments, each of the features associated with an online advertisement may be a factor that impacts the way a consumer perceives the online advertisement.

At block 406, the model training module 208 may obtained labeled data that indicates a view status of each online advertisements. Each view status of an online advertisement may indicate whether the online advertisement is viewed or not viewed by a user. In some embodiments, the labeled data may be obtained by tracking eye movements of one or more users as the users are viewing the online advertisements, or from user responses to a survey regarding the online advertisements.

At block 408, the model training module 208 may develop a perception model based on the feature quantification values and the labeled data. In various embodiments, the model training module 208 may develop the perception model 110 by applying a machine learning classifier, such as a SVM classifier, to integrate the labeled data and the feature quantification values of the online advertisements. The integration of the labeled data and the feature quantification values may train the parameters of the machine learning model and generate the perception model 110.

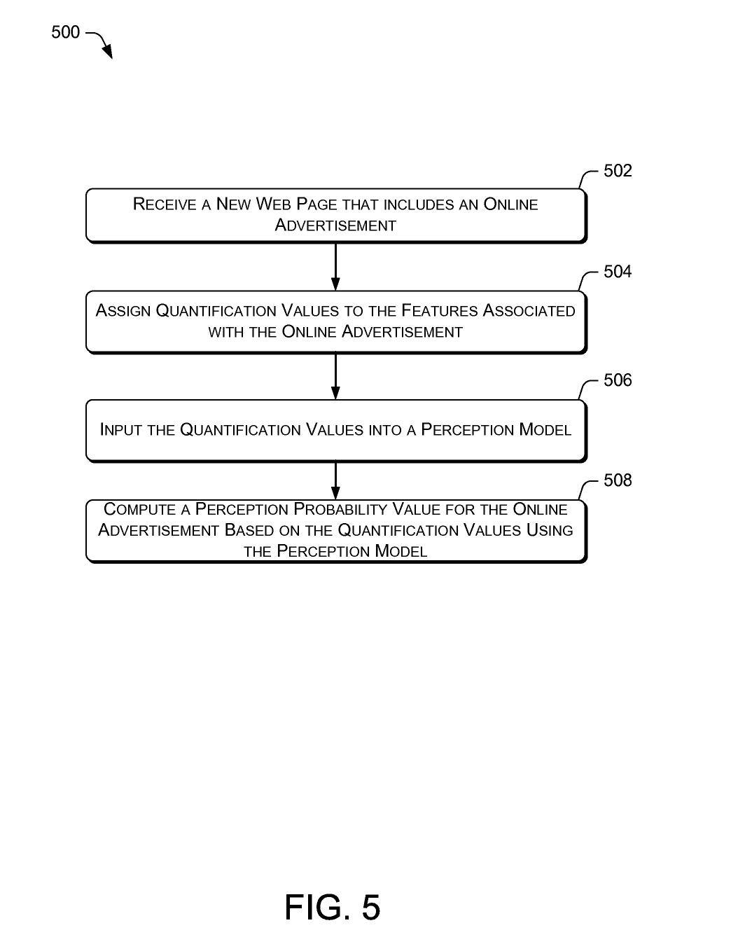

FIG. 5 is a flow diagram that illustrates an example process 500 for obtaining a perception probability value for an online advertisement using the perception model. The example process 500 further illustrates block 308 of the example process 300. At block 502, the advertisement analysis module 212 may receive a new web page that includes an online advertisement. In various embodiments, the online advertisements may include a hyperlink that enables a consumer to navigate to a different web page, as well as text or graphics.

At block 504, the advertisement analysis module 212 may assign quantification values to the features associated with the online advertisement. In various embodiments, the feature quantification module 206 may use a machine classification algorithm to detect features in the new web page that are associated with the online advertisement and assign quantification values to such features.

At block 506, the advertisement analysis module 212 may input the feature quantification values into a perception model, such as the perception model 110. In various embodiments, the perception model 110 may be a supervised learning model, such as a support vector machine (SVM) classification mode that is trained using model training data.

At block 508, the advertisement analysis module 212 may compute a perception probability for the online advertisement based on the feature quantification values using the perception model 110. The perception probability value may indicate the probability that a consumer is likely to view the online advertisement. For example, the perception probability value may be expressed as a percentage value, in which a higher percentage value indicates a higher likelihood of being viewed, while a lower percentage value indicates a lower likelihood of being viewed.

The advertisement perception predictor may forecast the effectiveness of an online advertisement by predicting whether the online advertisement is likely to be viewed by consumers. The ability to predict whether an online advertisement is likely to be viewed by consumers may enable the adoption of an online advertising pricing model that more closely parallels the expectations of the online advertisements in receiving returns for their online advertising investments.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer-readable medium storing computer-executable instructions that, when executed, cause one or more processors to perform acts comprising:
training a perception model for determining a perception probability value of an online advertisement in a web page, the perception probability value indicating a likelihood that a consumer is likely to view the online advertisement; and
applying the perception model to the online advertisement to determine a perception probability value for the online advertisement.

2. The computer-readable medium of claim 1, further comprising instructions that, when executed, cause the one or more processors to perform an act of determining an impression fee for the online advertisement based at least on the perception probability value.

3. The computer-readable medium of claim 2, wherein the determining includes determining the impression fee for the online advertisement based on the perception probability value in combination with one or more of a click-through rate or a sale conversion rate.

4. The computer-readable medium of claim 1, wherein the training includes:
assigning a quantification value to each of one or more feature associated with each online advertisement in a group of online advertisements;
obtaining label data that includes a view status for the each online advertisement in the group of online advertisements, each view status indicating whether a corresponding online advertisement is viewed by a user; and
developing a perception model based on quantification values of the group of online advertisements and the labeled data.

5. The computer-readable medium of claim 4, wherein the assigning includes at least one of assigning a float quantification values that indicate a magnitude of a first feature a particular online advertisement in the group of online advertisements or assigning a Boolean quantification value that indicates whether a second feature is found in the particular advertisement.

6. The computer-readable medium of claim 4, wherein a view status of a particular online advertisement is obtained via eye movement tracking as the user views a corresponding web page or manually supplied information regard the corresponding web page.

7. The computer-readable medium of claim 4, wherein the developing includes applying a machine learning classifier to feature quantification values and view status labels of a plurality of samples to generate the perception model, each sample being a pairing of a corresponding online advertisement from the group of online advertisements and a web page that displays the corresponding online advertisement.

8. The computer-readable medium of claim 7, further comprising instructions that, when executed, cause the one or more processors to perform an act of testing the perception model by:
generating a test perception probability value for each of the plurality of samples; and
comparing test perception probability values and the view statuses of the group of online advertisements to determine an acceptability of the perception model for determining the perception probability value of the online advertisement.

9. The computer-readable medium of claim 8, wherein the comparing includes:
determining that the perception model is acceptable when each of the test perception probability values is within a predetermined threshold range of a related view status; and
determining that the perception model is unacceptable when each of a predetermined amount of the test perception probability values is outside of the predetermined threshold range of a corresponding view status.

10. The computer-readable medium of claim 1, wherein the applying includes:
assigning a corresponding quantification value to each of one or more features associated with the online advertisement;
inputting one or more corresponding quantification values into the perception model; and
computing the perception probability value for the online advertisement based on the one or more corresponding quantification values using the perception model.

11. The computer-readable medium of claim 10, wherein the one or more features includes at least one of a display-screen based feature, a browsing behavior feature, an advertisement visual feature, a proximate web page visual feature, and a brand recognition feature.

12. The computer-readable medium of claim 11, wherein the brand recognition feature indicates a degree of popularity for a brand that is described in a specific online advertisement.

13. The computer-readable medium of claim 1, wherein the perception model is a support vector machine (SVM) classifier model.

14. A computer-implemented method, comprising:
assigning a quantification value to each of one or more feature associated with each online advertisement in a group of online advertisements;
obtaining label data that includes a view status for the each online advertisement in the group of online advertisements, each view status indicating whether a corresponding online advertisement is viewed by a user;
developing a perception model based on quantification values of the group of online advertisements and the labeled data; and
applying the perception model to an online advertisement to determine a perception probability value for the online advertisement.

15. The computer-implemented method of claim 14, further comprising determining an impression fee for the online advertisement based on the perception probability value in combination with one or more of a click-through rate or a sale conversion rate.

16. The computer-implemented method of claim 14, wherein the assigning includes at least one of assigning a float quantification values that indicate a magnitude of a first feature a particular online advertisement in the group of online advertisements or assigning a Boolean quantification value that indicates whether a second feature is found in the particular advertisement.

17. The computer-implemented method of claim 14, wherein the developing includes applying a machine learning classifier to feature quantification values and view status labels of a plurality of samples to generate the perception model, each sample being a pairing of a corresponding online advertisement from the group of online advertisements and a web page that displays the corresponding online advertisement.

18. The computer-implemented method of claim 17, further comprising testing the perception model by:
generating a test perception probability value for each of the plurality of samples;
determining that the perception model is acceptable when each test perception probability value is within a predetermined threshold range of a related view status; and
determining that the perception model is unacceptable when each of a predetermined amount of test perception probability values is outside of the predetermined threshold range of a corresponding view status.

19. The computer-implemented method of claim 14, wherein the applying includes:
assigning a corresponding quantification value to each of one or more features associated with the online advertisement;
inputting one or more corresponding quantification values into the perception model; and
computing the perception probability value for the online advertisement based on the one or more corresponding quantification values using the perception model.

20. A computing device, comprising:
one or more processors; and
a memory that includes a plurality of computer-executable components, the plurality of computer-executable components comprising:
a model training component that trains a perception model for determining a perception probability value of an online advertisement in a web page, the perception probability value indicating a likelihood that a consumer is likely to view the online advertisement;
an advertisement analysis component that applies the perception model to the online advertisement to determine a perception probability value for the online advertisement; and
a payment assessment component that determines an impression fee for the online advertisement based at least on the perception probability value.
